(19) United States
(12) Patent Application Publication
(10) Pub. No.: US 2001/0051936 A1
(43) Pub. Date: Dec. 13, 2001

(54) System and method for determining an optimum or near optimum solution to a problem

(76) Inventor: Zbigniew Michalewicz, Charlotte, NC (US)

Correspondence Address: McGuireWoods, 1750 Tysons Boulevard, Suite 1800, Tysons Corner, McLean, VA, 22102-4215, US

(21) Appl. No.: 09/837,194

(22) Filed: Apr. 19, 2001

Related U.S. Application Data
(60) Provisional application No. 60/198,643, filed on Apr. 20, 2000.

(51) Int. Cl. G06N 5/02; G06F 17/00

(52) U.S. Cl. 706/46

(57) ABSTRACT

A method and system for returning an optimum (or near-optimum) solution to a nonlinear programming problem. By specifying a precision coefficient, the user can influence the flexibility of the returned solution. A population of possible solutions is initialized based on input parameters defining the problem. The input parameters may include a minimum progress and a maximum number of iterations having less the minimum progress. The solutions are mapped into a search space that converts a constrained problem into an unconstrained problem. Through multiple iterations, a subset of solutions is selected from the population of solutions, and variation operators are applied to the subset of solutions so that a new population of solutions is initialized and then mapped. If a predetermined number of iterations has been reached, that is if the precision coefficient has been satisfied, the substantially optimum solution is selected from the new population of solutions. The system and method can be used to solve various types of real-world problems in the fields of engineering and operations research.

### CROSS-REFERENCE TO RELATED APPLICATIONS

This application claims priority to U.S. Provisional Application Ser. No. 60/198,643, filed on Apr. 20, 2000, the entire contents of which are herein incorporated by reference.

### BACKGROUND

1. Field of the Invention

The present invention generally relates to the field of nonlinear programming and, more particularly, the present invention relates to a system and method implementing nonlinear programming techniques to determine an optimum or near-optimum solution to a real-world problem.

2. Background Description

Nonlinear programming is a technique that can be used to solve problems that can be put into a specific mathematical form. Specifically, nonlinear programming problems are solved by seeking to minimize a scalar function of several variables subject to other functions that serve to limit or define the values of the variables. These other functions are typically called constraints. The entire mathematical space of possible solutions to a problem is called the search space and is usually denoted by the letter “S”. The part of the search space in which the function to be minimized meets the constraints is called the feasibility space and is usually denoted by the letter “F”.

Nonlinear programming is a difficult field, and often many complexities must be conquered in order to arrive at a solution or “optimum” to a nonlinear programming problem. For example, some problems exhibit local “optima”; that is, some problems have spurious solutions that merely satisfy the requirements of the derivatives of the functions. However, nonlinear programming can be a powerful tool to solve complex real-world problems, assuming a problem can be characterized or sampled to determine the proper functions and parameters to be used in the nonlinear program.

Due to the complexity of nonlinear programming techniques, computers are often used to implement a nonlinear program. It should be noted that the term “programming” as used in the phrase “nonlinear programming” refers to the planning of the necessary solution steps that is part of the process of solving a particular problem. This choice of name is incidental to the use of the terms “program” and “programming” in reference to the list of instructions that is used to control the operation of a modem computer system. Thus, the term “NLP program” for nonlinear programming software is not a redundancy.

Almost any type of problem can be characterized in a way that allows it to be solved with the help of NLP techniques. This is because any abstract task to be accomplished can be thought of as solving a problem. The process of solving such a problem can, in turn, be perceived as a search through a space of potential solutions. Since one usually seeks the best solution, this task can be characterized as an optimization process. However, nonlinear programming techniques are especially useful for solving complex engineering problems. These techniques can also be used to solve problems in the field of operations research (OR) which is a professional discipline that deals with the application of information technology for informed decision-making.

The majority of numerical optimization algorithms for nonlinear programming are based on some sort of local search principle; however, there is quite a diversity of these methods. Of course, then, classifying them neatly into separate categories is difficult because there are many different options. By example, some incorporate heuristics for generating successive points to evaluate, others use derivatives of the evaluation function, and still others are strictly local, being confined to a bounded region of the search space. But these numerical optimization algorithms all work with complete solutions and they all search the space of complete solutions. Most of these techniques make assumptions about the objective function or constraints of the problem (e.g., linear constraints, quadratic function, etc), and most of these techniques also use some type of penalty function to handle problem-specific constraints.

One of the many reasons that there are so many different approaches to nonlinear programming problems is that no single method has emerged as superior to all others. In general, it has been thought impossible to develop a deterministic method for finding the best global solution in many situations that would be better than an exhaustive search. There is thus a need for a method and system that can be used to find optimal or near-optimal solutions for almost any nonlinear programming problem. Ideally, the method and system should be able to handle both linear and nonlinear constraints.

### SUMMARY

The present invention can be used to find an optimal (or near-optimal) solution to any nonlinear programming problem. The objective function need not be continuous or differentiable. The method and system according to the present invention will return the optimum (or near-optimum) solution which is feasible (i.e., it satisfies problem-specific constraints).

According to the method of the present invention, a population of possible solutions is initialized based on input parameters defining the problem. The input parameters may include, for example, a minimum progress and a maximum number of iterations having less the minimum progress (where the minimum progress may be the precision coefficient). The solutions are mapped into a search space by a decoder. For most problems the input parameters also include such features as, for example, all variables of the problem, the domains for the variables, the formula for the objective function, and the constraints (linear and nonlinear).

After mapping the problem into a search space (which converts the constrained problem into an unconstrained problem) the method of the present invention then proceeds by repeatedly selecting a subset of solutions from the population of solutions, applying variation operators to the subset of solutions so that a new population of solutions is initialized, and mapping the new population of solutions into the search space. Finally, when termination condition is satisfied (e.g., the maximum number of iterations having less than the minimum progress has been reached, i.e., if the precision coefficient has been satisfied), the substantially optimum solution is selected from the new population of solutions. This solution can be supplied to a file for later retrieval, or supplied directly into another computerized process. The variation operators mentioned above include both unary and binary operators.

A computer software program or hardwired circuit can be used to implement the present invention. In the case of software, the program can be stored on media such as, for example, magnetic media (e.g., diskette, tape, or fixed disc) or optical media such as a CD-ROM. Additionally, the software can be supplied via the Internet or some other type of network. A workstation or personal computer that typically runs the software includes a plurality of input/output devices and a system unit that includes both hardware and software necessary to provide the tools to execute the method of the present invention.

### BRIEF DESCRIPTION OF THE DRAWINGS

FIG. 1 shows a flowchart which illustrates the method of the present invention;

FIG. 2 is a diagram illustrating how a space is mapped into a cube in order to initialize a search space according to the invention;

FIG. 3 illustrates the influence of the location of a reference point on a transformation according to the invention;

FIG. 4 shows a line segment of a non-convex space that follows from the mapping of the present invention;

FIG. 5 is a diagram that illustrates mapping from a cube into a convex space according to the invention;

FIG. 6 shows a line segment in a non-convex space and corresponding sub-intervals resulting from mapping which is implemented according to the present invention;

FIG. 7 illustrates a workstation on which the present invention is implemented; and

FIG. 8 illustrates further detail of an embodiment of hardware for implementing the system and method of the present invention.

### DETAILED DESCRIPTION

The present invention is directed to optimally or near-optimally providing solutions to complex real-world problems which may be encountered in any number of situations. By way of illustration and not to limit the present invention in any manner, a type of problem that the system and method of the present invention may solve is a design engineering problem such as the design of an engine which is modeled by an array of parameters (e.g., 100 different variables) such as pressures, lengths, component type and the like. These parameters may be labeled x₁, x₂, . . . x₁₀₀. In providing a solution to this and other problems, the present invention will minimize some very complex objective that is given as a formula of these 100 variables, or as a procedure to execute using these 100 variables.

Also, in this specific illustration there may also be problem-specific constraints. For example, the total of three dimensions (e.g., x₄, x₅, and x₆) of a particular part on the engine may have to be designed to stay between 10 and 15. This constraint may be modeled as a pair of linear constraints such that:

x₄+x₅+x₆≧10, and

x₄+x₅+x₆≦15

Similarly, it is possible to have nonlinear constraints (e.g., a volume should stay within some limit). Thus, the problem can be specified by the objective function, the variables, their domains, and a set of constraints.

The general nonlinear programming (NLP) problem is to find x so as to:

optimize ƒ(\vec{x}), \vec{x}(x₁, . . . , x₁)ε [symbol] ⁿ,

where \vec{x}εF [symbol] [symbol] ⁿ. The objective function “f” is defined on the search space S [symbol] [symbol] ⁿ and the set F [symbol] S defines the feasible region. Usually, the search space S is defined as an n-dimensional rectangle in [symbol] ⁿ (domains of variables defined by their lower and upper bounds):

l(i)≦xi≦u(i), 1≦i≦n,

whereas the feasible region F [symbol] S is defined by a set of m additional constraints (m≧0):

gⱼ(\vec{x})≦0, for j=1, . . . , q, and hⱼ(\vec{x})=0, for j=q+1, . . . , m.

It is a common practice to replace the equation hⱼ(\vec{x})=0 with a set of inequalities, hⱼ(\vec{x})≦δ and hⱼ(\vec{x})≧−δ for some small δ>0. Throughout the remaining portions of the disclosure, it is assumed that the above holds true.

Consequently, the set of constraints consists of m inequalities gⱼ(\vec{x})≦0, for j=1, . . . , m. After replacement of the equations with pairs of inequalities, the total number of inequality constraints is actually q+2·(m−q)=2m−q. However, to simplify the notation, it is assumed there are m inequality constraints. At any point \vec{x}εF, the constraints gⱼ that satisfy gⱼ(\vec{x})=0 are called the active constraints at \vec{x}.

The NLP problem has often been thought of as intractable; that is, it is impossible to develop a deterministic method for the NLP in the global optimization category, which would be better than an exhaustive search. However, this makes room for the system and method of the present invention extended by some constraint-handling methods such as described herein in accordance with the present invention. The evolutionary method and system of the present invention uses specialized operators and a decoder. The decoder is based on the transformation of a constrained problem to an unconstrained problem via mapping. This method has numerous advantages, including, not requiring additional parameters, not having a need to evaluate or penalize infeasible solutions, and easiness of approaching a solution located at the edge of a feasible region.

As previously mentioned, specialized operators are used to implement the invention. These operators “assume” that the search space is convex. The domain D is defined by ranges of variables (lₖ≦xₖ≦rₖ for k=1, . . . n) and by a set of constraints C. From the convexity of the set D it follows that for each point in the search space (x₁, . . . , xₙ)εD there exists a feasible range {left(k), right(k)} of a variable xₖ(l≦k≦n), where other variables xᵢ(i=1, . . . , k−1,k+1, . . . n) remain fixed. In other words, for a given (x₁, . . . , xₖ, . . . , xₙ)εD:

yε{left(k),right(k)}iff(x₁, . . . , xₖ₋₁, y, xₖ₊₁, . . . , xₙ)εD,

where all xᵢ's (i=1, . . . , k−1,k+1, . . . , n) remain constant. We assume also that the ranges {left(k), right(k)} can be efficiently computed.

If the set of constraints C is empty, then the search space D=Πₖ₌₁ⁿ{lₖ, rₖ} is convex; additionally left(k)=lₖ,right(k)=rₖ for k=1, . . . n. Therefore, the operators constitute a valid set regardless of the presence of the constraints.

Several operators based on floating point representation are used with the invention. The first three are unary operators, each representing a category of mutation. The other three operators are binary operators, representing various types of crossovers. The operators are discussed below.

Uniform Mutation

This operator requires a single parent \vec{x} and produces a single offspring \vec{x}′. The operator selects a random component kε(1, . . . , n) of the vector \vec{x}=(x₁, . . . , xₖ, . . . , xₙ) and produces \vec{x}′=(x₁, . . . , x′ₖ, . . . , xₙ), where x′ₖ is a random value (uniform probability distribution) from the range {left(k), right(k)}.

Boundary Mutation

This operator also requires a single parent \vec{x} and produces a single offspring \vec{x}′. The operator is a variation of the uniform mutation with x′ₖ being either left(k) or right(k), each with equal probability. The operator is constructed for optimization problems where the optimal solution lies either on or near the boundary of the feasible search space. Consequently, if the set of constraints C is empty, and the bounds for variables are quite wide, the operator is a nuisance. But this operator can prove extremely useful in the presence of constraints.

Non-uniform Mutation

This is a unary operator responsible for the fine tuning capabilities of the system and method of the present invention. The operator is defined as follows. For a parent \vec{x}, if the element xₖ was selected for this mutation, the result is \vec{x}′={x₁, . . . x′ₖ, . . . , x_{q}}, where:

$${x}_{k}^{′} = \{ \begin{matrix}{x}_{k} + Δ ( t , right ( k ) - {x}_{k} ) & if a random binary digit is 0 \\ {x}_{k} - Δ ( t , {x}_{k} - left ( k ) ) & if a random binary digit is 1.\end{matrix}$$

The function Δ(t,y) returns a value in the range [0,y] such that the probability of Δ(t,y) being close to 0 increases as t increases (t is the generation number). This property causes this operator to search the space uniformly initially (when t is small), and very locally at later stages. Δ(t,y) can be specified by the following function:

$$Δ ( t , y ) = y \cdot r \cdot {( 1 - \frac{t}{T} )}^{b} ,$$

where r is a random number from [0..1], T is the maximal generation number, and b is a system parameter determining the degree of non-uniformity.

Arithmetical Crossover

This binary operator is defined as a linear combination of two vectors. If \vec{x}₁ and \vec{x}₂ are crossed, the resulting offspring are:

\vec{x}′₁=a·x₁+(1−a)·x₂ and \vec{x}′₂=a·x₂+(1−a)·x₁.

This operator uses a random value aε[0..1], as it always guarantees closedness (\vec{x}′₁,\vec{x}′₂εD).

Simple Crossover

This is a binary operator such that if \vec{x}₁=(x₁, . . . , xₙ) and \vec{x}₂=(yₗ, . . . , yₙ) are crossed after the k-th position, the resulting offspring are:

\vec{x}′₁=(x₁, . . . xₖ, yₖ₊₁, . . . , yₙ) and \vec{x}′₂=(y₁, . . . yₖ, xₖ₊₁, . . . , xₙ).

Such an operator may produce offspring outside the domain D. To avoid this, the present invention uses the property of the convex spaces stating that there exists aε[0,1] such that:

\vec{x}′₁+{x₁, . . . , xₖ, yₖ₊₁·a+xₖ₊₁(1−a), . . . , yₙ·a+x·(1−a)}

and

\vec{x}′₂={y₁, . . . , yₖ, xₖ₊₁·a+yₖ₊₁·(1−a), . . . , xₙ·a+yₙ·(1−a)}

are feasible.

Heuristic Crossover

This operator is a unique crossover for the following reasons: (1) it uses values of the objective function in determining the direction of the search, (2) it produces only one offspring, and (3) it may produce no offspring at all. This operator generates a single offspring \vec{x}₃ from two parents, \vec{x}₁ and \vec{x}₂ according to the following rule:

\vec{x}₃=r·(\vec{x}₂−\vec{x}₁)+\vec{x}₂,

where r is a random number between 0 and 1, and the parent \vec{x}₂ is no worse than \vec{x}₁, i.e., ƒ(\vec{x}₂)≧ƒ(\vec{x}₁) for maximization problems and ƒ(\vec{x}₁)≦ƒ(\vec{x}₁) for minimization problems.

It is possible for this operator to generate an offspring vector which is not feasible. In such a case another random value r is generated and another offspring is created. If after w attempts no new solution meeting the constraints is found, the operator stops and produces no offspring. The heuristic crossover contributes towards the precision of the solution found, where its major responsibilities are (1) fine local tuning and (2) searching in the promising direction.

However, it is necessary to be able to handle cases where the feasible search space is not convex. In order for the present invention to be able to handle such cases, a decoder is used. In techniques based on decoders, a chromosome “gives instructions” on how to build a feasible solution. For example, a sequence of items for the classic knapsack problem can be interpreted as: “take an item if possible.” Such an interpretation would lead always to a feasible solution.

Several factors should be taken into account while using a decoder. A decoder imposes a mapping T between a feasible solution and decoded solution. It is important that this mapping satisfies several conditions. First, for each solution sεF there must be an encoded solution d. Also, each encoded solution d should correspond to a feasible solution s. All solutions in F should be represented by the same number of encodings d. Additionally, it is reasonable to expect that the transformation T is computationally fast and that it has a locality feature in the sense that small changes in the coded solution result in small changes in the solution, itself.

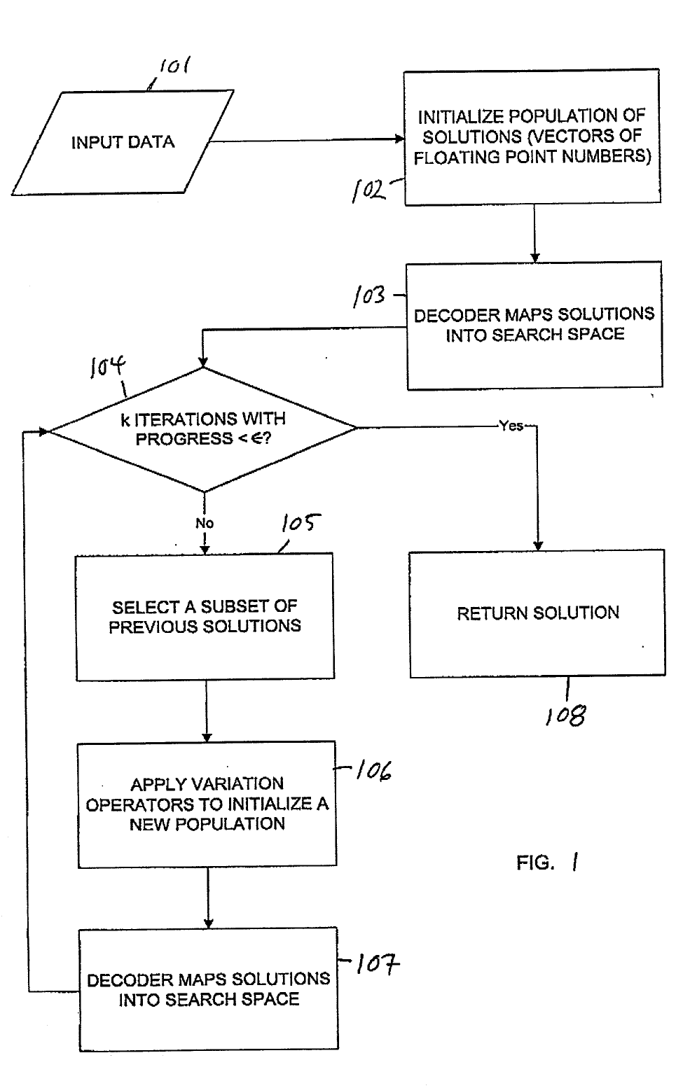

Now understanding the above, FIG. 1 shows a flowchart illustrating the method of the invention using a decoder which meets all the above requirements and the variation operators as described above. It should be well understood by those of ordinary skill in the art that FIG. 1 may equally represent a high level system block diagram of the present invention.

At step 101, input data is organized into modules. These modules may be created manually, or created by another program or routine in the computer software that is implementing the invention. In embodiments, one module includes the number of variables, their domains, and all linear constraints. In embodiments, another module includes the objective function, while a third module includes all nonlinear constraints.

At step 102, a population of solutions is initialized. That is, a number of potential solutions to the problem are generated by the method of the present invention. All solutions are vectors of floating point numbers. Each component of each vector is a number from the range [0..1]. At step 103, the decoder of the present invention initially maps the solutions into a search space. It is noted that each individual solution is mapped into a feasible solution from the real search space. The mechanism of this mapping is further described below.

Steps 104 through 107 describe the iterations that take place after the initial mapping in order to reach a final solution to the problem. At step 104, a termination condition is described. For example, if there have been “k” iterations with progress less than ε (the precision coefficient), the process stops and the current solution is returned at step 108. Initially, there have been no iterations, so steps 105-107 are performed until there have been “k” iterations. At step 105, a subset of solutions from the search space is selected according to a biased probability distribution, where better solutions have better chances for selection. One or more of the variation operators are applied to the subset at step 106 to arrive at a new, smaller population of solutions. The input file specifies the operators and their frequency. These new solutions are then mapped into the search space at step 107, and the process repeats until the condition at step 104 is met and the best or most optimum solution is returned at step 108. The returned best solution can be presented on a screen, stored in a file, or a numerical description of the solution can serve as input to another program or computerized process.

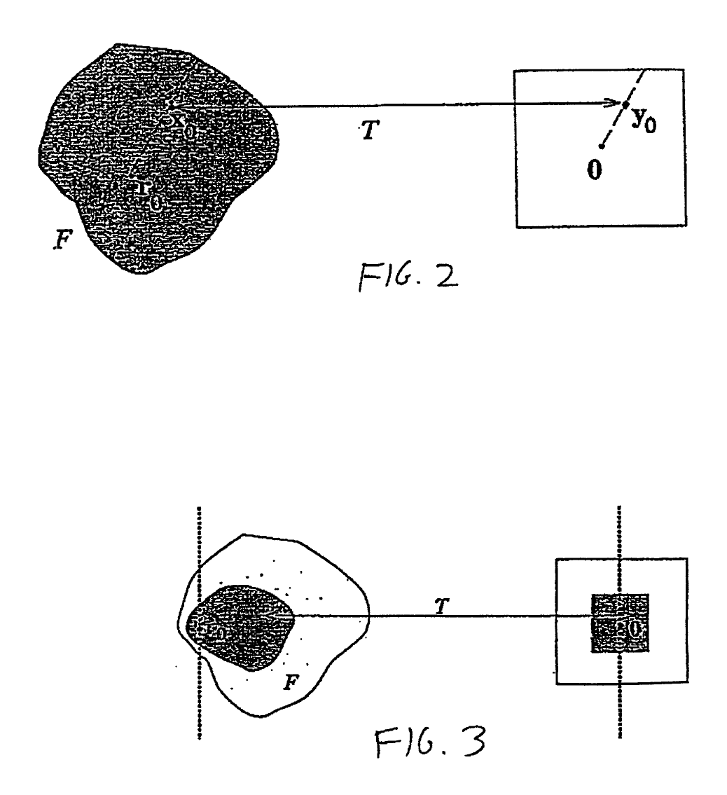

The mapping process and the decoder can be most readily understood by examining a nonlinear programming process. FIG. 2 shows a one-to-one mapping between an arbitrary convex feasible search space F and an n-dimensional cube [−1,1]ⁿ. An arbitrary (different than \vec{0}) point:

\vec{y}₀=(y_{0,1}, . . . , y_{0,n})ε[−1,1]ⁿ

defines a line segment from the vector \vec{0} to the boundary of the cube. This segment is described by:

yᵢ=y_{0,i}·t, for i=1, . . . , n where

t varies from 0 to tₘₐₓ=1/max {|y_{0,1}|, . . . , |y_{0,n}|}. For t=0, and for t=tₘₐₓ, \vec{y}=(y_{0,1}tₘₐₓ, . . . , y_{0,n}tₘₐₓ) a boundary condition of the [−1,1]ⁿ cube is represented. Consequently, the corresponding feasible point \vec{x}₀εF is defined as:

\vec{x}₀=\vec{r}₀+\vec{y}₀·τ,

where τ=τₘₐₓ/tₘₐₓ, and τₘₐₓ is determined with arbitrary precision by a binary search procedure such that

\vec{r}₀+\vec{y}₀·τₘₐₓ

is a boundary point of the feasible search space F. This mapping satisfies all the previously mentioned requirements for the decoder.

Apart from being one-to-one, the transformation is fast and has a locality feature. The corresponding feasible point \vec{x}₀εF is defined with respect to some reference point \vec{r}₀. Such a reference point is an arbitrary internal point of the convex set F. Note that convexity of the feasible search space is not necessary, but it is sufficient to assume the existence of the reference point \vec{r}₀ such that every line segment originating in \vec{r}₀ intersects the boundary of F at precisely one point. This requirement is satisfied for any convex set F.

This approach may be extended by the additional method of iterative solution improvement according to the present invention. The iterative solution improvement of the present invention is based on the relationship between the location of the reference point and the efficiency of the proposed approach. It is clear that the location of the reference point \vec{r}₀ has an influence on “deformation” of the domain of optimized function. The present invention optimized some other function which is topologically equivalent to the original function. For example, consider the case, shown in FIG. 3, where the reference point is located near the edge of the feasible region F. It is easy to notice a strong irregularity of transformation T. The part of the cube [−1,1]², which is on the left side of the vertical line, is transformed into a much smaller part of the set F than the part on the right side of this line.

According to the above considerations, it is profitable to localize the reference point in the neighborhood of the expected optimum, if this optimum is close to the edge of the set F. In such case the area between the edge of F and the reference point \vec{r}₀ is explored more precisely.

In the case of lack of information about approximate localization of the solution, the reference point is placed close to the geometrical center of the set F. This can be done by sampling set F and setting:

\vec{r}₀=1/kΣᵢ₌₁^{k}\vec{x}ᵢ,

where \vec{x}ᵢ consists of samples from F. It is also possible to take advantage of the mentioned effect for the purpose of iterative improvement of the best-found solution. To obtain this effect it is necessary to repeat the optimization process with a new reference point \vec{r}′₀ which is located on a line segment between the current reference point \vec{r}₀ and the best solution \vec{b} found to this point:

\vec{r}′₀=t·\vec{r}₀+(1−t)·\vec{b},

where tε(0,1] is close to zero. This change of the location of the reference point causes the found optimum to be explored more precisely in the next iteration in the neighborhood in comparison with the remaining part of the feasible region. Experiments have show that such a method usually provides good results for problems with optimal solutions localized on the edge of the feasible region.

The approach of the present invention can be also extended to handle non-convex search spaces (the original nonlinear programming problem). That is, the proposed technique of the present invention can handle arbitrary constraints for numerical optimization problems. The task is to develop a mapping φ, which transforms the n-dimensional cube [−1,1]ⁿ into the feasible region F of the problem. Note, that F need not be convex; it might be concave or even can consist of disjoint (non-convex) regions.

As shown in FIG. 4, this mapping φ is more complex than T defined earlier. Note that in FIG. 4 any line segment L which originates at a reference point \vec{r}₀εF may intersect a boundary of the feasible search space F in more than just one point.

Because of the complexity of this mapping, it may be necessary to take into account the domains of the variables. First, an additional one-to-one mapping g between the cube [−1,1]ⁿ and the search space S is defined (the search space S is defined as a Cartesian product of domains of all problem variables). Then the mapping g: [−1,1]ⁿ→S can be defined as:

g(\vec{y})=\vec{x},

where

$${x}_{i} = {y}_{i} \frac{u ( i ) - l ( i )}{2} + \frac{u ( i ) + l ( i )}{2} , for i = 1 , … , n$$

Indeed, for yᵢ=−1 the corresponding xᵢ=l(i), and for yᵢ=1 the corresponding xₗ=u(i).

A line segment L between any reference point \vec{r}₀εF and a point \vec{s} at the boundary of the search space S, is defined as:

L(\vec{r}₀, \vec{s})=\vec{r}₀+t·(\vec{s}+\vec{r}₀, for 0≦t≦1.

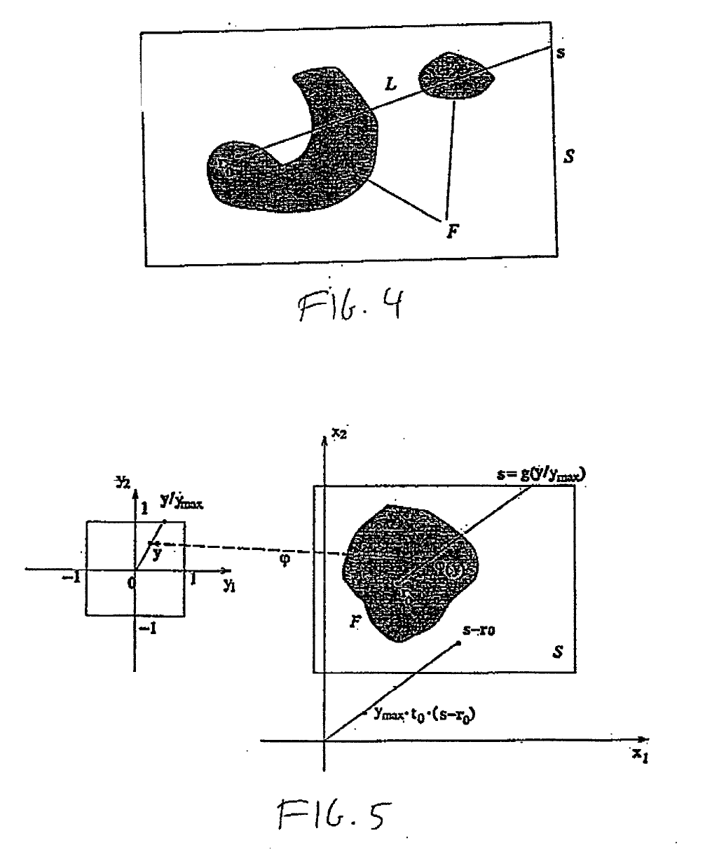

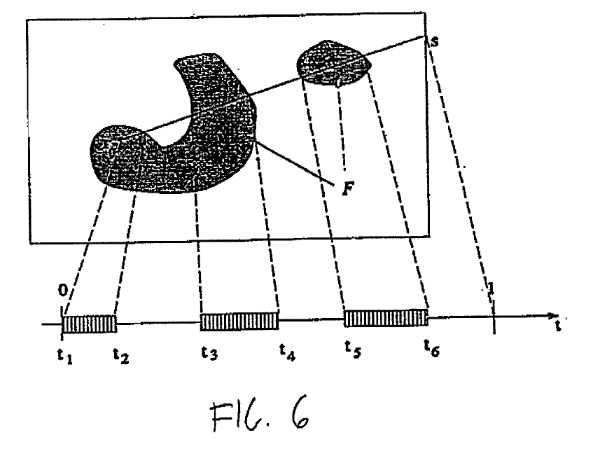

If the feasible search space F is convex, then the above line segment intersects the boundary of F in precisely one point, for some t₀ ε[0,1]. Consequently, for convex feasible search spaces F, it is possible to establish a one-to-one mapping φ:[−1,1]ⁿ as follows:

$$ϕ ( \vec{r} ) = \{ \begin{matrix}{\vec{r}}_{0} + {y}_{max} \cdot {t}_{0} \cdot ( g ( \vec{y} / {y}_{max} ) - {\vec{r}}_{0} ) & if \vec{y} \neq \vec{0} \\ {\vec{r}}_{0} & if y = \vec{0}\end{matrix}$$

where \vec{r}₀εF is a reference point, and yₘₐₓ=maxᵢ₌₁ⁿ|yₗ|. FIG. 5 illustrates the transformation. That is, FIG. 5 shows a mapping φ from the cube [−1,1]ⁿ into the convex space F (two-dimensional case), with the particular steps of the transformation.

Returning now to the general case of arbitrary constraints (i.e., non-convex feasible search spaces F), consider an arbitrary point yε[−1,1]ⁿ and a reference point, \vec{r}₀εF. A line segment L between the reference point \vec{r}₀ and the point \vec{s}=g(\vec{y}/yₘₐₓ) at the boundary of the search space S, is defined as before:

L(\vec{r}₀, \vec{s})=\vec{r}₀+t·(\vec{s}−\vec{r}₀), for 0≦t≦1,

However, the line segment may intersect the boundary of F in many points as shown in FIG. 4. In other words, instead of a single interval of feasibility [0,t₀] for convex search spaces, there may be several intervals of feasibility:

[t₁,t₂], . . . , [t₂ₖ₋₁, t₂ₖ].

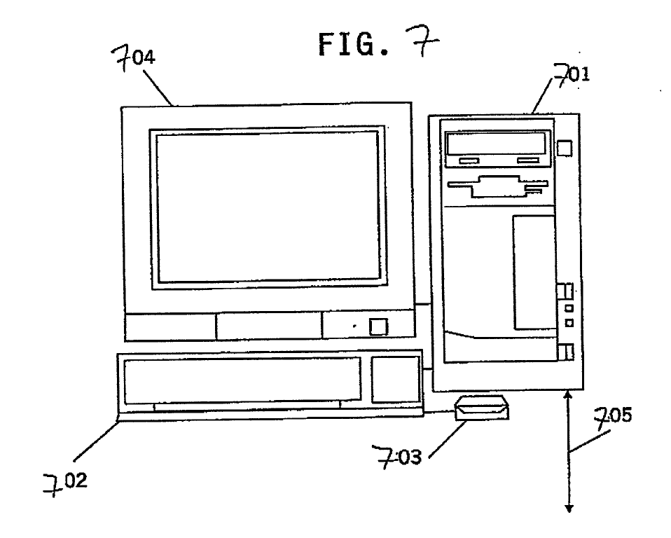

It is assumed that there are altogether k sub-intervals of feasibility for such a line segment and tᵢ's mark their limits. FIG. 6 shows a line segment in a non-convex space F and corresponding intervals for a two-dimensional case. As shown in FIG. 6:

t₁=0,tᵢ<tᵢ₊₁, for i=1, . . . , 2k−1, and t₂ₖ≦1.

Thus, it is necessary to introduce an additional mapping γ, which transforms interval [0,1] into the sum of intervals [t₂ᵢ₋₁,t₂ᵢ]. However, such a mapping γ rather between [0,1] and the sum of intervals (t₂ᵢ₋₁,t₂ᵢ] as follows:

γ:(0,1]→∪ᵢ₌₁^{k}(t₂ᵢ₋₁, t₂ᵢ].

Note that, due to this change, the left boundary point is lost. This is not a serious problem, since the lost points can be approached with arbitrary precision. However, there are important benefits to this definition. It is possible to “glue together” intervals which are open at one end and closed at another end. Additionally, such a mapping is one-to-one. There are many alternatives for defining such a mapping. For example, a reverse mapping:

δ:∪ᵢ₌₁^{k}(t₂ᵢ₋₁, t₂ᵢ]→(0,1]

can be defined as follows:

δ(t)=(t−t₂ᵢ₋₁+Σⱼ₌₁ⁱ⁻¹dⱼ)/d,

where dⱼ=t₂ⱼ−t₂ⱼ₋₁, d=Σⱼ₌₁^{k}dⱼ, and t₂ᵢ₋₁<t≦t₂ᵢ. The mapping y is reverse of δ:

$$γ ( a ) = {t}_{2 j - 1} + {d}_{j} \frac{a - δ ( {t}_{2 j - 1} )}{δ ( {t}_{2 j} ) - δ ( {t}_{2 j - 1} )} ,$$

where j is the smallest index such that a≦δ(t₂ⱼ).

From the above, the general decoder mapping φ is defined which is used as shown in FIG. 1 for the transformation of constrained optimization problem to an unconstrained optimization problem for every feasible set F. The mapping φ is given by the formula:

$$ϕ ( \vec{y} ) = \{ \begin{matrix}{\vec{r}}_{0} + {t}_{0} \cdot ( g ( \vec{y} / {y}_{max} ) - {\vec{r}}_{0} ) & if \vec{y} \neq \vec{0} , \\ {\vec{r}}_{0} & if y = \vec{0} ,\end{matrix}$$

where \vec{r}₀εF is a reference point, yₘₐₓ=maxᵢ₌₁ⁿ|yᵢ|, and t₀=γ(|yₘₐₓ|).

Finally, it is necessary to consider a method of finding points of intersection tᵢ as shown in FIG. 6. This is relatively easy for convex sets, since there is only one point of intersection. For non-convex sets, however, the problem is more complex.

In the embodiments of the invention, the following approach has been used to find the points of intersection for the non-convex sets. Consider any boundary point \vec{s} of S and the line segment L determined by this point and a reference point \vec{r}₀εF. There are m constraints gᵢ(\vec{x})≦0 and each of them can be represented as a function βᵢ of one independent variable t for a fixed reference point \vec{r}₀εF and the boundary point \vec{s} of S:

βᵢ(t)=gᵢ(L(\vec{r}₀,\vec{s})=gᵢ(\vec{r}₀+t·(\vec{s}−\vec{r})), for 0≦t≦1 and i=1, . . . , m.

As stated earlier, the feasible region need not be convex so it may have more than one point of intersection of the segment L with the boundaries of the set F. Therefore, the interval [0,1] is partitioned into v subintervals [vⱼ₋₁,v], where:

vⱼ−vⱼ₋₁=1/v(1≦j≦v),

so that equations βᵢ(t)=0 have, at most, one solution in every subinterval. The density v of the partition is adjusted experimentally. For all cases discussed in this disclosure v=20. In this case the points of intersection can be determined by a binary search. Once the intersection points between a line segment L and all constraints gᵢ(\vec{x})≦0 are known, one can then determine intersection points between this line segment L and the boundary of the feasible set F. The flexibility of the solution is achieved by evaluating a solution in a particular way. That is, several solutions in the neighborhood of the current solution, as determined by the precision coefficient, are evaluated and averaged. The computational method handles both linear and nonlinear constraints, and this is capable of handling convex and non-convex feasible search spaces in an efficient manner in accordance with the method and system of the present invention.

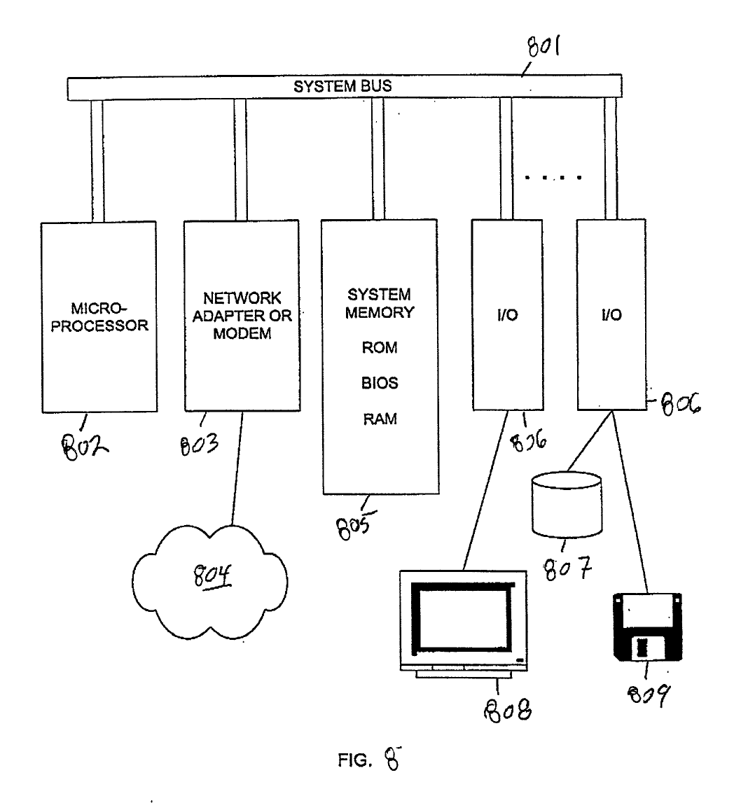

As previously mentioned, it is convenient to execute the method described above on a computer system which has been programmed with appropriate software. FIG. 7 illustrates a workstation on which the method of the present invention can be executed. Input/output (I/O) devices such as keyboard 702, mouse 703 and display 704 are used by an operator to provide input and view information related to the operation of the invention. A system unit 701 is connected to all of the I/O devices and contains memory, media devices, and a central processing unit (CPU), all of which together may execute the method of the present invention. These devices in combination with the appropriate software are the means for carrying out the various steps involved in implementing the method of the present invention.

As previously mentioned, appropriate computer program code in combination with the appropriate hardware may be used to implement the method of the present invention invention. This computer program code is often stored on storage media such as a diskette, hard disk, CD-ROM, DVD-ROM or tape. The media can also be a memory storage device or collection of memory storage devices such a read-only memory (ROM) or random access memory (RAM). Additionally, the computer program code can be transferred to a workstation over the Internet or some other type of network. The method of the present invention can equally be hardwired into a circuit or computer implementing the steps of the present invention.

FIG. 8 illustrates further detail of the system unit for the computer system shown in FIG. 7. The system is controlled by microprocessor 802, which serves as the CPU for the system. System memory 805 is typically divided into multiple types of memory or memory areas, such as read-only memory (ROM), random-access memory (RAM) and others. If the workstation is an IBM compatible personal computer, for example, the system memory also contains a basic input/output system (BIOS). A plurality of general input/output (I/O) devices 806 such as a keyboard or a mouse are connected to various devices including a fixed disk 807, a diskette drive 809 and a display 808. The system may include another I/O device, a network adapter or modem, shown at 803, for connection to a network 804. This network connection may be used to download the software implementing the present invention for execution on the computer system. A system bus 801 interconnects the major components 802, 803, 805 and 806 of FIG. 8.

It should be noted that the system as shown in FIGS. 7 and 8 is meant as an illustrative example only and should not be considered as a limiting factor in determining the scope of the present invention. For example, the present invention may be implemented on numerous types of general-purpose computer systems running operating systems such as Windows™ by Microsoft and various versions of UNIX and the like.

### EXAMPLE OF USE

The present invention is particularly useful in workflow management problems, process problems, and engineering problems. By way of illustrative example, assume that the optimization model of a particular engineering problem is as follows:

Minimize

$$0 \leq 85.334407 + 0.006858 {α}_{2} {x}_{5} + 0.0006262 {x}_{1} {x}_{1} - 0.0022053 {x}_{3} {x}_{5} \leq 92$$

$$90 \leq 80.51249 + 0.0071317 {x}_{2} {x}_{3} + 0.0029955 {x}_{1} {x}_{2} + 0.0021813 {x}_{3}^{2} \leq 110$$

$$20 \leq 9.300961 + 0.0047026 {x}_{3} {x}_{3} + 0.0012547 {x}_{1} {x}_{3} + 0.0019035 {x}_{3} {x}_{4} \leq 25 ,$$

For this particular function, the optimum solution is (\vec{x})=(78.0, 33.0, 29.995, 45.0, 36.776), with F(\vec{x})=−30665.5. Two constraints (upper bound of the first inequality and the lower bound of the third inequality) are active at the optimum. Note, however, that for most real problems this is not the case, i.e., neither the optimum solution nor the number of active constraints is known. The only reason for selecting the function F, as an example, is to underline the quality of the present invention.

At this stage, the system and method of the present invention can be used to find the best solution. The user then sets some parameters of the system such as, for example, population size, frequencies of operators, termination conditions (e.g., 5,000 generations) and the like. The system and method of the present invention then determines a feasible point (by random sampling of the search space) which will take a role of the reference point \vec{r}₀ (i.e., the first randomly generated feasible point was accepted as a reference point). Utilizing the above discussion, the present invention finds a solution of value −30664.5, which is a 0.0033 of one percent error. This is the optimum solution which is provided by the present invention.

It cannot be overemphasized that the practical applications of the present invention are almost unlimited. For example, the present invention can provide solutions to:

structural design systems;

flaw detection in engineered structures;

multiprocessor scheduling in computer networks;

physical design of integrated circuits;

scheduling activities for an array of different, diverse systems;

radar imaging; and

mass customization, to name just a few.

While the invention has been described in terms of several embodiments, those skilled in the art will recognize that the invention can be practiced with modification within the spirit and scope of the appended claims. The following claims are in no way intended to limit the scope of the invention to specific embodiments.

1. A method of finding a substantially optimal solution to a constrained problem, the method comprising the steps of:
initializing a population of possible solutions based on input parameters defining a problem;
mapping the population of possible solutions into a search space;
selecting a subset of solutions from the population of possible solutions;
applying at least one variation operator to the subset of solutions in order to provide a new population of solutions;
mapping the new population of solutions into the search space;
repeating the selecting, applying and mapping the new population of solutions steps until a termination condition is satisfied;
selecting the substantially optimum solution from the new population of solutions.

2. The method of claim 1, wherein the termination condition is one of the input parameters.

3. The method of claim 2, wherein the termination condition is based on a minimum progress and a maximum number of iterations having less the minimum progress.

4. The method of claim 3, wherein
the selecting the subset of solutions from the population of solutions step is performed when the maximum number of iterations having less than the minimum progress has not been reached; and
the selecting of the substantially optimum solution step is performed when the maximum number of iterations having less than the minimum progress has been reached.

5. The method of claim 1, wherein the selecting the substantially optimum solution step is performed after the repeating step.

6. The method of claim 1, further comprising organizing input data into modules prior to the initializing step, the optimum solution being based on the input data.

7. The method of claim 6, wherein the modules are separated into a plurality of modules, wherein:
a first of the plurality of modules including a number of variables, domains and linear constraints associated with the input data;
a second of the plurality of modules includes an objective function associated with the input data; and
a third of the plurality of modules includes nonlinear constraints associated with the input data.

8. The method of claim 1, wherein the mapping the population of possible solutions into a search space converts the constrained problem into an unconstrained problem.

9. The method of claim 1, wherein the at least one variation operator is two or more variation operators.

10. The method of claim 1 wherein the at least one variation operator includes both unary and binary operators.

11. The method of claim 10, wherein the unary and binary operators are selected from the group of a uniform mutation operator, boundary mutation operator, non-uniform mutation operator, arithmetical crossover operator, simple crossover operator and heuristic crossover operator

12. The method of claim 1, wherein the optimum solution is displayed to a user.

13. The method of claim 1, wherein the selecting a subset of solutions from the population of possible solutions includes the step of locating a substantial geometric center of the population of possible solutions.

14. A method of finding a substantially optimal solution to a constrained problem, the method comprising the steps of:
initializing a population of solutions based on input parameters defining a problem, the input parameters including a minimum progress and a maximum number of iterations having less the minimum progress;
mapping the population of solutions into a search space so that the constrained problem is converted into an unconstrained problem;
selecting a subset of solutions from the population of solutions if the maximum number of iterations having less than the minimum progress has not been reached;
applying variation operators to the subset of solutions so that a new population of solutions is initialized if the subset of solutions has been selected;
mapping the new population of solutions into the search space if the new population of solutions has been initialized; and
selecting the substantially optimum solution from the new population of solutions if the maximum number of iterations having less than the minimum progress has been reached.

15. The method of claim 14, wherein the variation operators include both unary and binary operators.

16. An apparatus for finding a substantially optimal solution to a constrained problem, the apparatus comprising:
means for mapping a population of solutions into a search space so that the constrained problem is converted to an unconstrained problem;
means for creating an initial population of solutions based on input parameters defining the problem;
means for iteratively selecting a subset of solutions from a population of solutions;
means for iteratively applying at least one variation operator to the subset of solutions in order to provide a new population of solutions; and
means for selecting the substantially optimum solution from the new population of solutions after a termination condition is satisfied.

17. The apparatus of claim 16, wherein the termination condition is an input parameter which is based on a minimum progress and a maximum number of iterations having the minimum progress.

18. The apparatus of claim 17, further comprising means for determining if the predetermined maximum iterations has been reached, the predetermined maximum iterations is equal to the maximum number of iterations having less than the minimum progress.

19. A computer program product for enabling a computer system to find a substantially optimal solution to a constrained problem, the computer program product including a medium with a computer program embodied thereon, the computer program comprising:
computer program code for mapping a population of solutions into a search space so that the constrained problem is converted into an unconstrained problem;
computer program code for creating an initial population of solutions based on input parameters defining the problem, the input parameters including a minimum progress and a maximum number of iterations having the minimum progress;
computer program code for selecting a subset of solutions from a population of solutions;
computer program code for applying variation operators to the subset of solutions so that a new population of solutions is initialized;
computer program code for determining if the maximum number of iterations having less than the minimum progress has been reached; and
computer program code for selecting the substantially optimum solution from the new population of solutions.

20. The computer program product of claim 19, wherein the variation operators include both unary and binary operators.

21. A programmed computer system which is operable to find a substantially optimal solution to a constrained problem by performing the steps of:
initializing a population of solutions based on input parameters defining the problem, the input parameters including a minimum progress and a maximum number of iterations having the minimum progress;
mapping the population of solutions into a search space so that the constrained problem is converted into an unconstrained problem;
selecting a subset of solutions from the population of solutions if the maximum number of iterations having less than the minimum progress has not been reached;
applying variation operators to the subset of solutions so that a new population of solutions is initialized if the subset of solutions has been selected;
mapping the new population of solutions into the search space if the new population of solutions has been initialized; and
selecting the substantially optimum solution from the new population of solutions if the maximum number of iterations having less than the minimum progress has been reached.
